(19) United States
(12) Patent Application Publication
(10) Pub. No.: US 2009/0300906 A1
(43) Pub. Date: Dec. 10, 2009

(54) STATOR MANUFACTURING APPARATUS

(75) Inventors: Shunichi UMINO, Utsunomiya-shi (JP); Kohei Fujinoto, Utsunomiya-shi (JP); Tohru Ikeda, Utsunomiya-shi (JP); Shinji Kazama, Iruma-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD, Tokyo (JP)

(21) Appl. No.: 12/475,909

(22) Filed: Jun. 1, 2009

(30) Foreign Application Priority Data
Jun. 4, 2008 (JP) 2008-146598

(51) Int. Cl. H02K 15/00

(52) U.S. Cl. 29/732

(57) ABSTRACT

A nozzle unit includes first, second, and third nozzles for discharging a sealant, and is movable toward and away from a stator by a vertically moving unit. The stator is disposed in a position facing the nozzle unit and is angularly movable successively through given angles by a rotary unit. The first, second, and third nozzles are moved radially outwardly in synchronism with each other by a link mechanism, and then lowered by the vertically moving unit at a position facing a first filling groove or a second filling groove of the stator. The first, second, and third nozzles thus lowered introduce the sealant into the first filling groove or the second filling groove.

### BACKGROUND OF THE INVENTION

1. Field of the Invention

The present invention relates to a stator manufacturing apparatus for manufacturing a stator for use in a rotary electric machine such as an electric motor, an electric generator, or the like, and more particularly to a stator manufacturing apparatus for manufacturing a stator having coils whose junctions are insulated by bodies of a resin which is introduced into the stator.

2. Description of the Related Art

Heretofore, there has been known a stator fabricated by preparing separate cores each comprising an arcuate yoke and a pole extending radially from the yoke, and winding conductive wires around the poles of the separate cores to produce coils on the poles.

As disclosed in Japanese Patent No. 4073705, the present applicant has proposed a stator structure having a plurality of insulators serving as separate cores and a plurality of coils wound respectively around the insulators. After the separate cores are interconnected into an annular shape and housed in a case, a sealant of a resin or the like is introduced into the case around the junctions of the coils and cured to insulate the junctions.

In recent years, there have been demands for a shortened period of time to be consumed to manufacture such a stator for thereby producing the stator more efficiently.

### SUMMARY OF THE INVENTION

It is a general object of the present invention to provide a stator manufacturing apparatus of simple structure for manufacturing a stator by quickly introducing a resin around the junctions of coils for insulating the junctions reliably and stably.

According to the present invention, there is provided a stator manufacturing apparatus for manufacturing a stator having a plurality of cores with respective coils wound therearound, the cores being interconnected in an annular shape, the coils having ends connected at junctions, the stator being connected to feeders for being connected to an external circuit, by introducing a resin to the junctions and curing the introduced resin, comprising: a plurality of nozzles for discharging the resin, the nozzles being disposed in facing relation to the stator and displaceable radially with respect to the stator; a nozzle link mechanism for displacing the nozzles in synchronism with each other; a vertically moving mechanism for vertically moving the nozzles with respect to the stator; and a rotary mechanism for angularly displacing the stator.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a plan view of a stator manufactured by a stator manufacturing apparatus according to an embodiment of the present invention;

FIG. 2 is an enlarged plan view of separate cores of the stator shown in FIG. 1;

FIG. 3 is an enlarged fragmentary side elevational view of an outer circumferential side of a first filling groove in the stator shown in FIG. 1;

FIG. 4 is a side elevational view of the stator manufacturing apparatus according to the embodiment of the present invention;

FIG. 5 is a perspective view of the stator manufacturing apparatus shown in FIG. 4;

FIG. 6 is a plan view of the stator manufacturing apparatus shown in FIG. 4;

FIG. 7 is an enlarged bottom view of a nozzle unit of the stator manufacturing apparatus;

FIG. 8 is an enlarged plan view of first through third nozzles, which are held closely to each other, of the nozzle unit shown in FIG. 7;

FIG. 9 is an enlarged plan view of the first through third nozzles, which are spaced radially outwardly from each other, of the nozzle unit shown in FIG. 8;

FIG. 10 is a side elevational view of the first and second nozzles of the nozzle unit shown in FIG. 7;

FIG. 11 is a side elevational view of the third nozzle of the nozzle unit shown in FIG. 7;

FIG. 12 is an enlarged front elevational view of a vertically movable unit and a shift unit of the stator manufacturing apparatus;

FIG. 13 is an enlarged side elevational view, partly cut away, of the vertically movable unit and the shift unit shown in FIG. 12;

FIG. 14 is a side elevational view of a rotary unit and a feed mechanism of the stator manufacturing apparatus;

FIG. 15 is an enlarged front elevational view of the rotary unit and the feed mechanism of the stator manufacturing apparatus;

FIG. 16 is an enlarged side elevational view of the rotary unit and the feed mechanism shown in FIG. 14;

FIGS. 17A through 17C are views showing the manner in which the first through third nozzles introduce a sealant into the first filling groove over a protrusive member therein;

FIGS. 18A through 18C are views showing the manner in which the first through third nozzles introduce a sealant into the first filling groove over a first terminal therein;

FIGS. 19A through 19C are views showing the manner in which the first through third nozzles introduce a sealant into a first space in the first filling groove;

FIG. 20 is a view showing the manner in which a sealant is additionally introduced into the first filling groove which has been supplied with the sealant; and

FIG. 21 is a view showing the manner in which the third nozzle operates to apply a sealant to a first bus tab of the stator.

### DESCRIPTION OF THE PREFERRED EMBODIMENTS

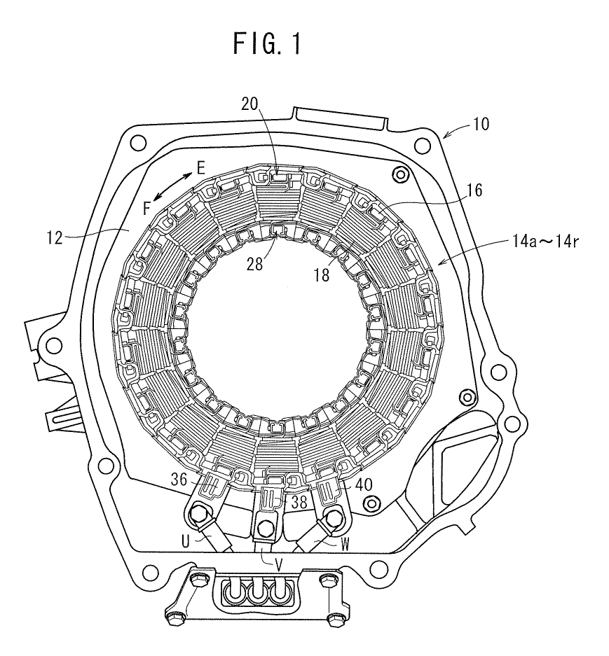

A stator 10 manufactured by a stator manufacturing apparatus according to an embodiment of the present invention will first be described below with reference to FIGS. 1 through 3.

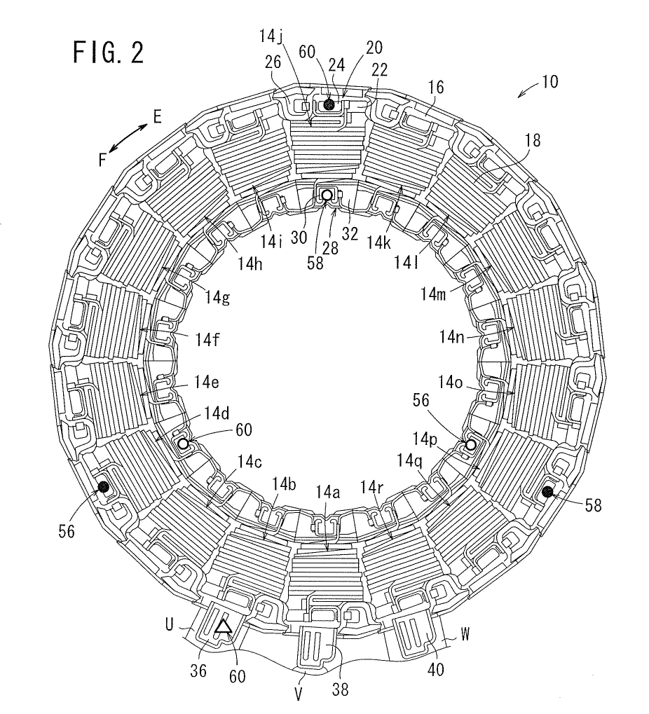

As shown in FIGS. 1 and 2, the stator 10 is a three-phase wye-connected stator having a hollow housing 12, three-phase input terminals (feeders) U, V, W disposed in the housing 12 for being connected to an external circuit, and eighteen separate cores 14a through 14r disposed in the housing 12. Coils 18 are wound respectively around the separate cores 14a through 14r with insulators 16 of a resin material interposed therebetween. The coils 18 are connected to the input terminals U, V, W by joint wires (not shown). The separate cores 14a through 14r are assembled in an annular pattern along an inner circumferential surface of the housing 12. Each of the separate cores 14a through 14r is coupled to an adjacent one of them, and the coils 18 on the adjacent separator cores are electrically connected to each other.

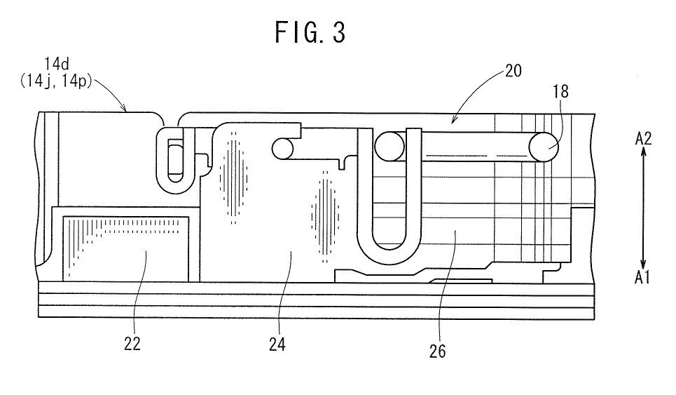

A first filling groove 20 is defined annularly by the interconnected eighteen separate cores 14a through 14r in an outer circumferential portion of the stator 10. Specifically, the first filling groove 20 is defined between outer circumferential walls of the separate cores 14a through 14r and the inner circumferential surface of the housing 12. As shown in FIG. 3, the first filling groove 20 accommodates therein a protrusive portion 22 projecting to a given height from the bottom of the first filling groove 20 and a first terminal 24 disposed adjacent to the protrusive portion 22 and connected to coils 18. The first filling groove 20 includes a first space 26 defined adjacent to the first terminal 24. The protrusive portion 22, the first terminal 24, and the first space 26 are provided at the radially outer end of each of the separate cores 14a through 14r.

A second filling groove 28 is defined annularly in an inner circumferential portion of the stator 10. The second filling groove 28 faces the junctions of the coils 18 through inner circumferential walls of the insulators 16 of the respective separate cores 14a through 14r (see FIG. 2). The second filling groove 28 accommodates therein a second terminal 30 connected to coils 18 and includes a second space 32 defined adjacent to the second terminal 30. The second terminal 30 and the second space 32 are provided at the radially inner end of each of the separate cores 14a through 14r.

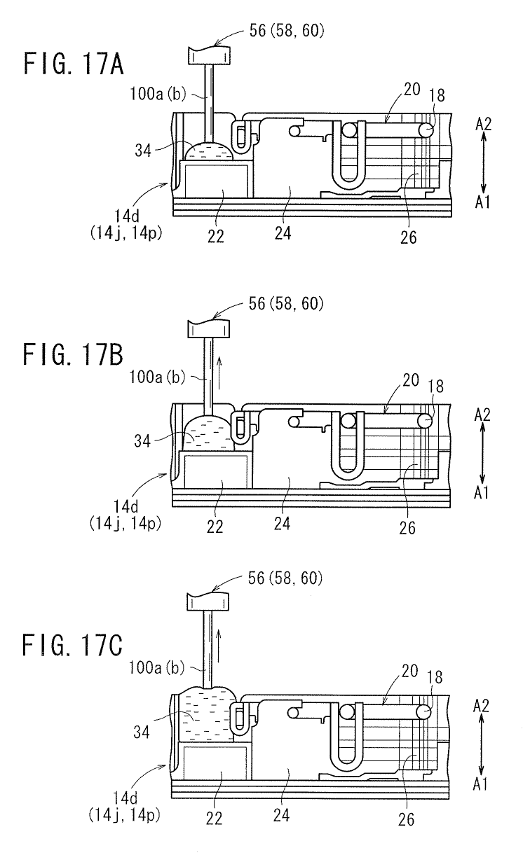

A sealant 34 is introduced into the first and second filling grooves 20, 28 (see FIGS. 17A, 17B, 17C through 19A, 19B, 19C). When the sealant 34 is cured with heat, the junctions of the coils 18 are secured to the separate cores 14a through 14r and the housing 12 and insulated by the sealant 34. The sealant 34 comprises a thermosetting resin such as silicone or the like, for example, which is normally in a liquid phase having an appropriate level of viscosity and can be cured with heat.

First, second, and third bus tabs 36, 38, 40 are disposed near the respective input terminals U, V, W and project radially outwardly from the first filling groove 20. The ends of the coils 18 which are disposed in the first filling grooves 20 are connected to the input terminals U, V, W by the joint wires (not shown) in the first, second, and third bus tabs 36, 38, 40.

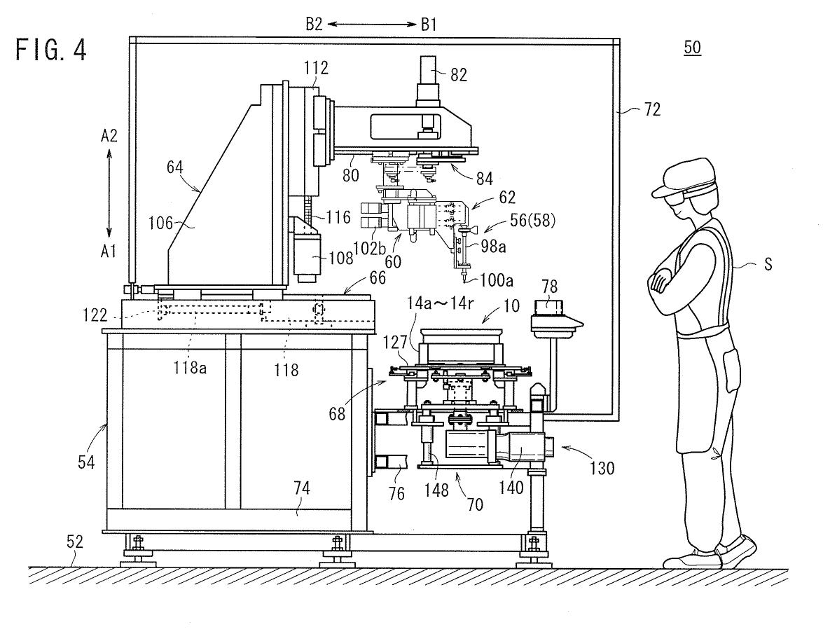

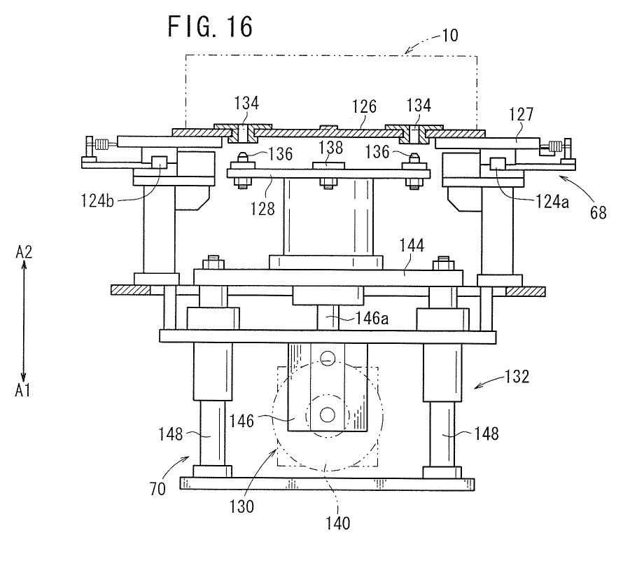

A stator manufacturing apparatus 50 for manufacturing the stator 10 will be described below with reference to FIGS. 4 through 16.

The stator manufacturing apparatus 50 comprises a frame 54 mounted on a floor 52, a nozzle unit 62 mounted on the frame 54 and having first, second, and third nozzles 56, 58, 60 for introducing the sealant 34 into the stator 10, a vertically moving unit (vertically moving mechanism) 64 for vertically moving the nozzle unit 62 in the directions indicated by the arrows A1, A2, a shift unit (shift mechanism) 66 for horizontally moving the nozzle unit 62 in the directions indicated by the arrows B1, B2, a feed mechanism 68 for feeding the stator 10 to a position facing the nozzle unit 62, and a rotary unit (rotary mechanism) 70 for rotating the stator 10 when the sealant 34 is introduced into the stator 10.

A box-shaped casing 72 is mounted on the frame 54 in covering relation to the nozzle unit 62, the vertically moving unit 64, and the shift unit 66 (see FIG. 4). The frame 54 comprises a first base 74 supporting the vertically moving unit 64 thereon and a second base 76 supporting the feed mechanism 68 and the rotary unit 70. The second base 76 is positioned near the operator S in the direction indicated by the arrow B1 (see FIG. 4), and projects horizontally from a side of the first base 74 in the direction indicated by the arrow B1.

An electronic balance 78 is mounted on the second base 76 at its end near the operator S. The electronic balance 78 allows the operator S to confirm the amount of the sealant 34 that is discharged from the nozzle unit 62. The electronic balance 78 is electrically connected to a discharge controller (not shown) for controlling the amount of the sealant 34 that is discharged from the first, second, and third nozzles 56, 58, 60 of the nozzle unit 62. The operator S can confirm the amount of the sealant 34 that is discharged from the nozzle unit 62 by seeing indications on the electronic balance 78 and can make adjustments to the amount of the sealant 34 to be discharged from the nozzle unit 62.

The nozzle unit 62 comprises a base plate 80 vertically movable in the directions indicated by the arrows A1, A2 by the vertically moving unit 64, a first rotary actuator 82 mounted on the upper part of the base plate 80, the first, second, and third nozzles 56, 58, 60 for introducing the sealant 34 into the stator 10, and a link mechanism 84 actuatable by the first rotary actuator 82 for moving the first, second, and third nozzles 56, 58, 60 toward and away from each other.

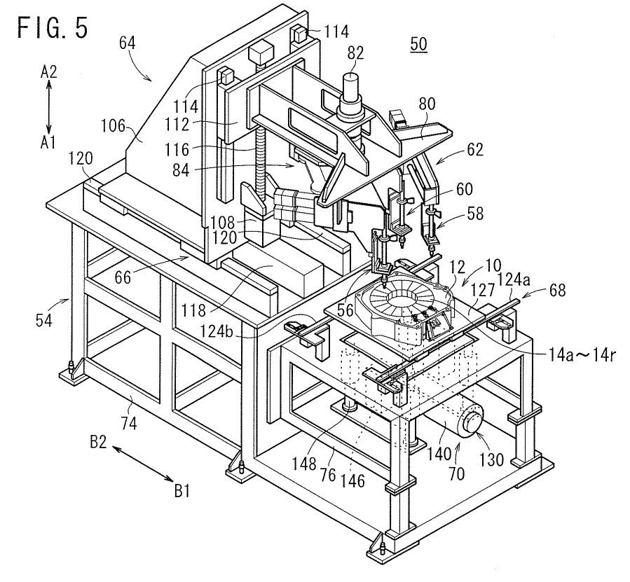

The base plate 80 has an end coupled to a vertically movable block 112, to be described later, of the vertically moving unit 64 for vertical movement in the directions indicated by the arrows A1, A2 (see FIGS. 4 and 5). The base plate 80 extends substantially parallel to the floor 52 (see FIG. 4).

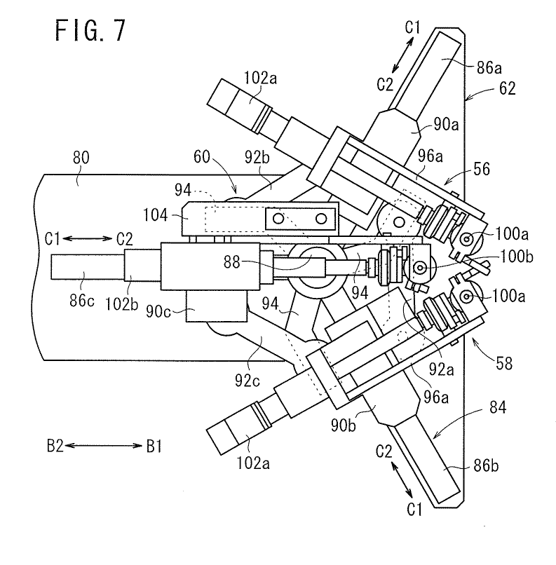

As shown in FIG. 7, three slide rails (guide mechanisms) 86a, 86b, 86c are mounted on a lower surface of the base plate 80. The slide rails 86a, 86b, 86c extend radially outwardly, each in the direction indicated by the arrow C1, from the first rotary actuator 82, and are angularly spaced at equal angular intervals of 120°. Specifically, the slide rails 86a, 86b are angularly spread toward the other end of the base plate 80 in the direction indicated by the arrow B1, and the slide rail 86c extends toward the end of the base plate 80 which is coupled to the vertically movable block 112, in coaxial alignment with the base plate 80.

The first rotary actuator 82 comprises a rotational drive source such as a stepping motor or the like which makes a rotary motion when energized, and has a rotatable shaft, not shown, connected to a rotor 88, to be described later, of the link mechanism 84. The rotatable shaft of the first rotary actuator 82 rotates in a given direction at a given rotational speed based on an output signal that is supplied from a controller, not shown, to the first rotary actuator 82.

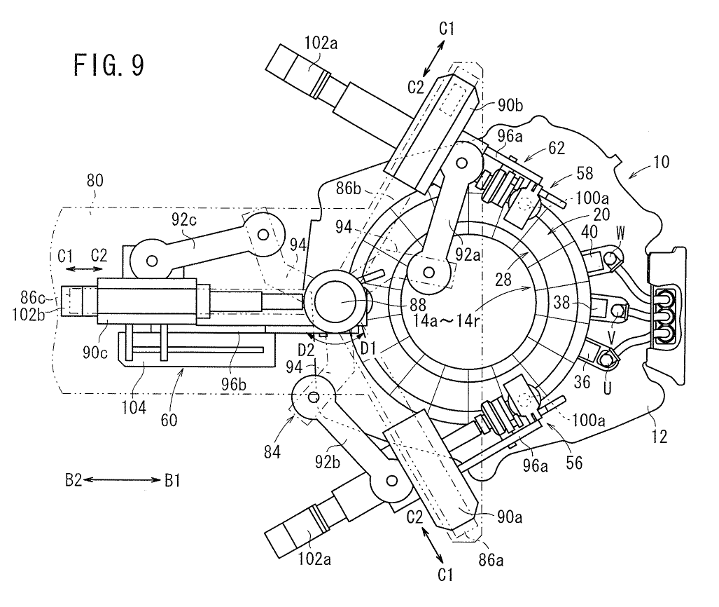

As shown in FIGS. 7 through 9, the link mechanism 84, which is disposed on the lower surface of the base plate 80, comprises the rotor 88 connected to the first rotary actuator 82 for rotation thereby, a plurality of sliders 90a, 90b, 90c movable respectively along the slide rails 86a, 86b, 86c on the base plate 80, and a plurality of arms 92a, 92b, 92c operatively connecting the rotor 88 to the sliders 90a, 90b, 90c. In FIG. 9, the stator 10 disposed below the nozzle unit 62 is schematically shown.

The rotor 88, which is rotatably supported on the other end of the base plate 80 in the direction indicated by the arrow B1, has three support bars 94 projecting radially outwardly each in the direction indicated by the arrow C1. The support bars 94 are angularly spaced by equal angular intervals around the central axis of the rotor 88, and have radially outer distal ends angularly movably coupled to respective ends of the arms 92a, 92b, 92c.

The sliders 90a, 90b, 90c, each in the form of a block, have respective lower surfaces on which the respective first, second, and third nozzles 56, 58, 60 are mounted. The other ends of the arms 92a, 92b, 92c are pivotally supported on respective sides of the sliders 90a, 90b, 90c.

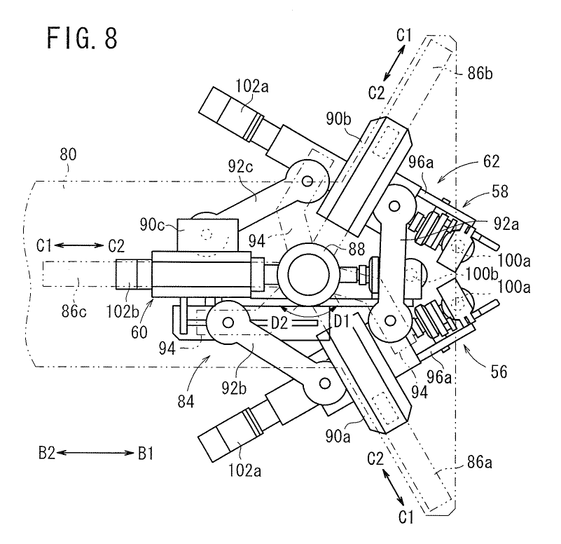

When the rotor 88 is rotated about its own axis by the first rotary actuator 82, the support bars 94 are rotated thereby to turn the respective arms 92a, 92b, 92c, which push or pull the respective sliders 90a, 90b, 90c radially along the respective slide rails 86a, 86b, 86c. At this time, depending on the direction in which the rotor 88 is rotated, the sliders 90a, 90b, 90c are moved radially inwardly toward each other in the directions indicated by the arrows C2, as shown in FIG. 8, or are moved radially outwardly away from each other in the directions indicated by the arrows C1, as shown in FIG. 9. The directions in which the sliders 90a, 90b, 90c are moved, i.e., the directions indicated by the arrows C1, C2 can be changed by changing the directions in which the first rotary actuator 82 is rotated, i.e., the directions indicated by the arrows D1, D2 in FIGS. 8 and 9.

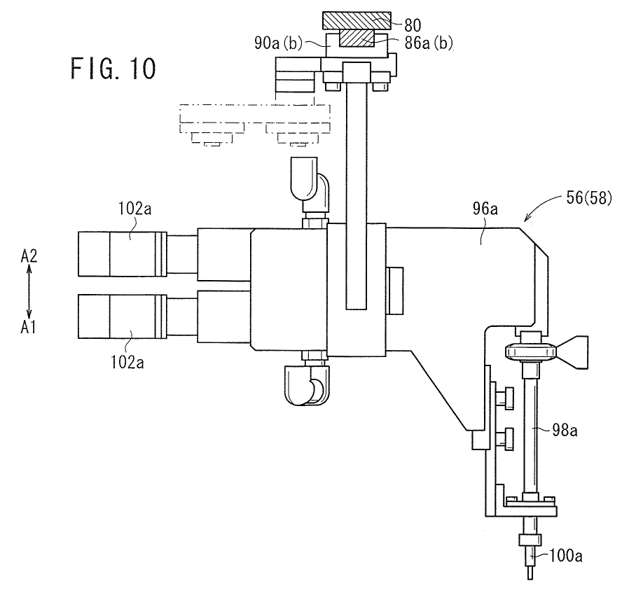

As shown in FIG. 10, each of the first and second nozzles 56, 58 comprises a joint block 96a fixed to the slider 90a (90b), a mixer 98a held by the joint block 96a for mixing two liquids of different types into the sealant 34, a nozzle port 100a connected to the mixer 98a for discharging the sealant 34, and a pair of supply pumps 102a mounted on the joint block 96a for supplying the sealant 34 to the nozzle port 100a.

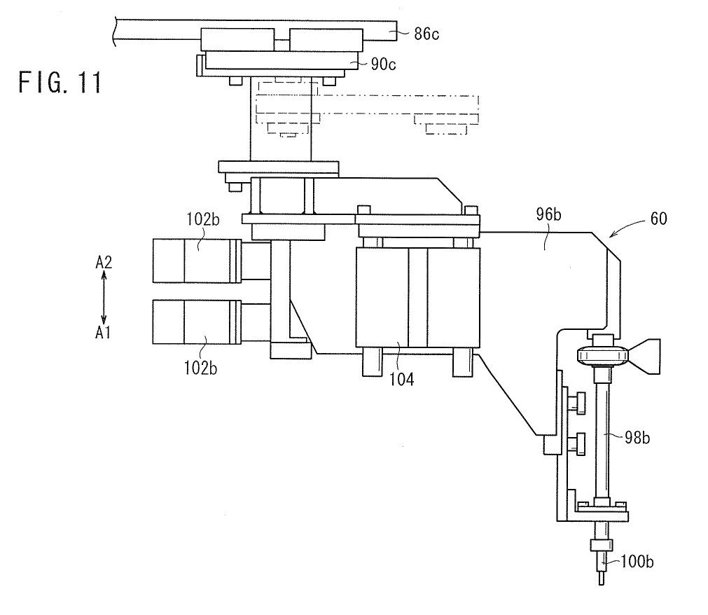

As shown in FIG. 11, the third nozzle 60 comprises a joint block 96b fixed to the slider 90c, a mixer 98b held by the joint block 96b for mixing two liquids of different types into the sealant 34, a nozzle port 100b connected to the mixer 98b for discharging the sealant 34, and a pair of supply pumps 102b mounted on the joint block 96b for supplying the sealant 34 to the nozzle port 100b.

The third nozzle 60 also includes a nozzle cylinder (nozzle lowering mechanism) 104 acting between the nozzle port 100b and the mixer 98b, and the joint block 96b, for lowering the nozzle port 100b by a predetermined distance with respect to the slider 90c and the joint block 96b in the direction indicated by the arrow A1.

Since the nozzle port 100a, the mixer 98a, and the joint block 96a are fixed to each other, the first and second nozzles 56, 58 are not vertically movable with respect to the sliders 90a, 90b, but vertically movable in the directions indicated by the arrows A1, A2 only by the vertically moving unit 64.

The first and second nozzles 56, 58 are inclined a given angle to the direction in which the base plate 80 extends, and the third nozzle 60 is held in coaxial alignment with the base plate 80. Therefore, the first through third nozzles 56, 58, 60 are angularly spaced at equal angular intervals and arranged in a substantially triangular pattern (see FIGS. 7 through 9) as with the slide rails 86a, 86b, 86c.

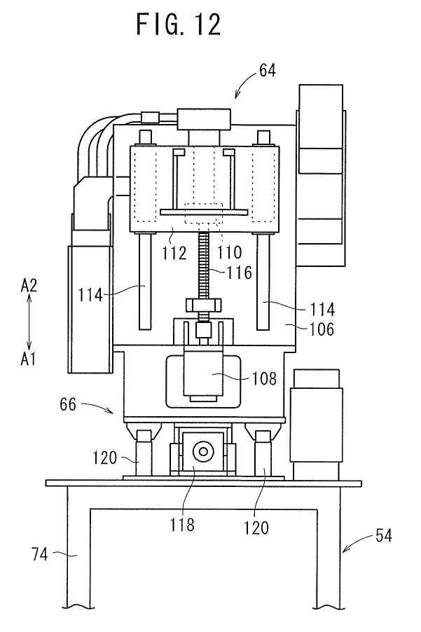

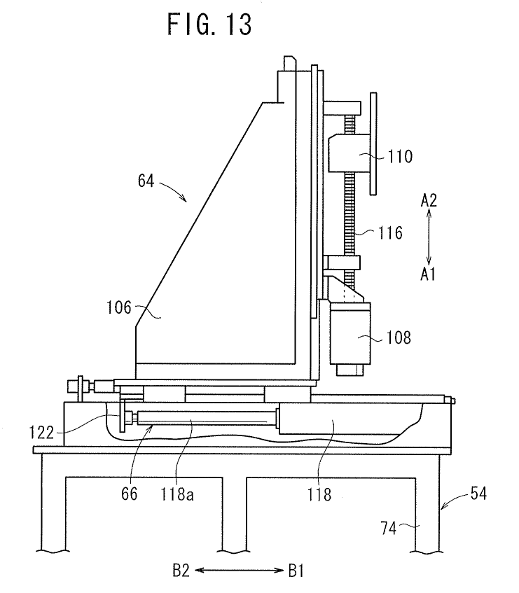

As shown in FIGS. 12 and 13, the vertically moving unit 64 is disposed above an upper end of the first base 74 of the frame 54, and is movable substantially horizontally in the directions indicated by the arrows B1, B2 (see FIG. 13) by the shift unit 66. The vertically moving unit 64 comprises a body 106 movable with respect to the first base 74, a displaceable member 110 mounted on a side of the body 106 and vertically movable by a second rotary actuator 108, a vertically movable block 112 coupled to the displaceable member 110, and a pair of first guide rails 114 mounted on the body 106 for guiding the vertically movable block 112 vertically in the directions indicated by the arrows A1, A2.

The second rotary actuator 108, which comprises a rotational drive source such as a stepping motor or the like, is mounted on a lower portion of the side of the body 106 and has an upwardly projecting drive shaft coupled to a rotatable shaft 116 that is rotatably supported on the side of the body 106. The rotatable shaft 116 is externally threaded and held in threaded engagement with the displaceable member 110.

When the rotatable shaft 116 is rotated about its own axis by the second rotary actuator 108, the displaceable member 110 moves along the rotatable shaft 116 vertically in the directions indicated by the arrows A1, A2. The vertically movable block 112 coupled to the displaceable member 110 then moves along the pair of the first guide rails 114, vertically moving the nozzle unit 62 which is held on the vertically movable block 112.

The shift unit 66 is mounted on the upper end of the first base 74, and disposed between the body 106 of the vertically moving unit 64 and the first base 74. The shift unit 66 comprises a first cylinder 118 for pulling the body 106 along the upper surface of the first base 74 toward the second base 76 in the direction indicated by the arrow B1, and a pair of second guide rails 120 mounted on the upper end of the first base 74 for guiding the body 106 in the directions indicated by the arrows B1, B2.

The first cylinder 118 is disposed centrally on the upper end of the first base 74. The second guide rails 120 are disposed on each side of the first cylinder 118 and spaced apart from each other by a given distance (see FIG. 12). The first cylinder 118 has a rod 118a movable axially back and forth in the directions indicated by the arrows B1, B2 when compressed air, for example, is supplied to and discharged from the first cylinder 118. The rod 118a has a distal end coupled to a flange 122 mounted on an end of the body 106.

When the first cylinder 118 is supplied with compressed air, the rod 118a is moved toward the second base 76 in the direction indicated by the arrow B1. The vertically moving unit 64 including the body 106 is also moved toward the second base 76, i.e., toward the operator S, in the direction indicated by the arrow B1, thereby moving the nozzle unit 62 toward the operator S. At this time, the body 106 of the vertically moving unit 64 is guided by the pair of the second guide rails 120 along a longitudinal axis of the stator manufacturing apparatus 50 in the directions indicated by the arrows B1, B2.

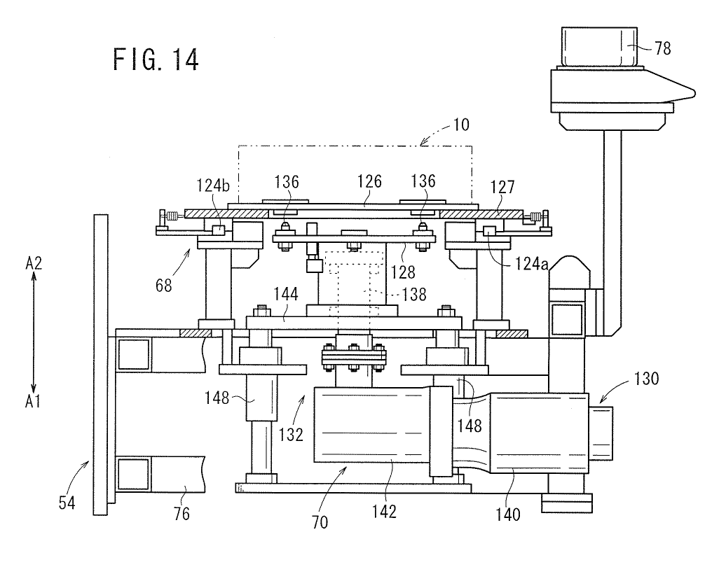

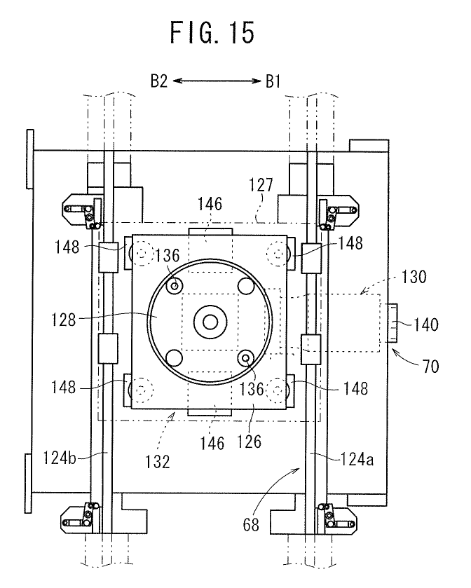

As shown in FIGS. 14 and 15, the feed mechanism 68 is disposed over the second base 76 of the frame 54. The feed mechanism 68 moves a pallet 127 carrying the stator 10 thereon into a given working position facing the nozzle unit 62 from outside of the stator manufacturing apparatus 50. After the sealant 34 has been introduced into the stator 10, the feed mechanism 68 unloads the stator 10 together with the pallet 127 from the working position to a position outside of the stator manufacturing apparatus 50. The feed mechanism 68 includes two spaced feed rails 124a, 124b along which the pallet 127 is fed to the working position.

As shown in FIGS. 14 through 16, the rotary unit 70 is disposed beneath the feed mechanism 68 of the second base 76 in the direction indicated by the arrow A1. The rotary unit 70 comprises a holder 128 for holding the stator 10 with the intermediary of an adapter 126, a rotational drive mechanism 130 for angularly displacing the stator 10 through the holder 128, and a moving mechanism 132 for moving the stator 10 in unison with the holder 128 upwardly in the direction indicated by the arrow A2.

The holder 128 is in the form of a plate having a pair of positioning pins 136 on its upper surface for insertion into respective holes 134 defined in the adapter 126. The positioning pins 136 project to a given height from the upper surface of the holder 128, and are positioned diametrically opposite to each other across the center of the holder 128.

When the pallet 127 carrying the stator 10 thereon is placed on the upper surface of the holder 128, the holder 128 is moved upwardly in the direction indicated by the arrow A2 by the moving mechanism 132 until the positioning pins 136 are inserted respectively into the holes 134 in the adapter 126 that is mounted on a lower end of the stator 10.

The adapter 126 and the stator 10 are now positioned with respect to the holder 128 of the rotary unit 70 and held against relative angular displacement with respect to the holder 128.

The rotational drive mechanism 130 has a vertical transmission shaft 138 coupled centrally to the holder 128 for transmitting rotary drive power from the rotational drive mechanism 130 to the holder 128.

The rotational drive mechanism 130 comprises a drive motor 140 extending substantially parallel to the holder 128 and energizable based on an output signal from the non-illustrated controller, a speed reducer 142 connected to the drive motor 140 for outputting the rotary drive power from the drive motor 140 at a predetermined speed reduction ratio, and the transmission shaft 138 which connects the speed reducer 142 and the holder 128 to each other. The rotational drive mechanism 130 is held by a base plate 144 which lies substantially parallel to the floor 52.

The drive motor 140, which comprises a stepping motor, for example, has its rotating direction and rotational speed controllable by the output signal from the non-illustrated controller.

The transmission shaft 138 extends vertically in the directions indicated by the arrows A1, A2 perpendicularly to the axis of the drive motor 140, and is rotatably held by the base plate 144. The rotary drive power from the drive motor 140 is transmitted from the speed reducer 142 in a direction substantially perpendicular to the axis of the drive motor 140 to the transmission shaft 138.

The holder 128 is coupled to an upper end of the transmission shaft 138, which transmits the rotary drive power from the drive motor 140 to the holder 128. The holder 128 is thus rotated through a given angular interval by the drive motor 140.

The moving mechanism 132 comprises a pair of second cylinders 146 held by the second base 76 and a plurality of guide rods 148 for guiding the base plate 144 for vertical movement. The second cylinders 146 have respective rods 146a movable axially back and forth in the directions indicated by the arrows A, A2 when compressed air, for example, is supplied to and discharged from the second cylinders 146. The rods 146a have distal ends coupled to the base plate 144.

When the second cylinders 146 are supplied with compressed air, the rods 146a are displaced upwardly in the direction indicated by the arrow A2 toward the nozzle unit 62. Therefore, the base plate 144, the holder 128, and the rotational drive mechanism 130 are also moved in unison upwardly in the direction indicated by the arrow A2. The stator 10 held on the holder 128 is brought toward the nozzle unit 62. The stator 10 can be rotated through the given angular interval when the rotational drive mechanism 130 is actuated.

The stator manufacturing apparatus 50 according to the embodiment of the present invention is basically constructed as described above. Operation and advantages of the stator manufacturing apparatus 50 will be described below with reference to FIGS. 2, 4 through 20. It is assumed that the stator manufacturing apparatus 50 is initially in a preparatory state wherein the nozzle unit 62 is brought to a highest position by the vertically moving unit 64, the nozzle unit 62 and the vertically moving unit 64 are displaced to the first base 74 in the direction indicated by the arrow B2 by the shift unit 66, and the first through third nozzles 56, 58, 60 of the nozzle unit 62 are brought closely to each other, as shown in FIG. 4.

In the stator 10 shown in FIG. 2, the separate core closest to the input terminal V is denoted by 14a, and the remaining separate cores that are arranged successively clockwise in the direction indicated by the arrow E from the separate core 14a are denoted respectively by 14b, 14c, 14d, . . . , 14r.

First, as shown in FIGS. 14 and 15, the stator 10 carried on the pallet 127 is moved into a position facing the rotary unit 70 from outside of the stator manufacturing apparatus 50 by the feed mechanism 68. Then, the stator 10 is positioned by a positioning mechanism, not shown. The moving mechanism 132 of the rotary unit 70 moves the holder 128 upwardly in the direction indicated by the arrow A2 (FIG. 14), inserting the positioning pins 136 into the respective holes 134 in the adapter 126, and elevates the adapter 126 and the stator 10 upwardly. The stator 10 is now lifted off the pallet 127, and the adapter 126 is positioned with respect to the holder 128.

Then, the second rotary actuator 108 of the vertically moving unit 64 is operated to rotate the rotational shaft 116 about its own axis to cause the displaceable member 110 to lower the vertically movable block 112. The nozzle unit 62 held by the vertically movable block 112 is now lowered toward the stator 10 in the direction indicated by the arrow A1 (FIG. 4). At the same time, the first rotary actuator 82 of the nozzle unit 62 is operated based on an output signal from the non-illustrated controller to rotate the rotor 88 counterclockwise in the direction indicated by the arrow D1 (FIG. 8). The sliders 90a, 90b, 90c are pushed by the respective arms 92a, 92b, 92c to move along the respective slide rails 86a, 86b, 86c radially outwardly in the directions indicated by the arrows C1.

When the rotational speed of the first rotary actuator 82 is controlled by the non-illustrated controller, the rotational speed of the rotor 88 and the distance by which the sliders 90a, 90b, 90c are moved are controlled for moving the nozzle ports 100a, 100b of the first through third nozzles 56, 58, 60 fixed to the sliders 90a, 90b, 90c to a position facing the first filling groove 20 of the stator 10.

Specifically, as shown in FIG. 9, the first through third nozzles 56, 58, 60 are angularly spaced at equal angular intervals of 120° around the rotor 88. At this time, the third nozzle 60 faces the separate core 14j of the stator 10 which is diametrically opposite to the input terminal V, the first nozzle 56 faces the separate core 14d near the input terminal U which is angularly spaced counterclockwise from the third nozzle 60 in the direction indicated by the arrow F, and the second nozzle 58 faces the separate core 14p near the input terminal W which is angularly spaced clockwise from the third nozzle 60 in the direction indicated by the arrow E. The positions where the first through third nozzles 56, 58, 60 are located at this time are indicated by solid circular dots in FIG. 2.

The vertically moving unit 64 is further actuated to move the radially outwardly spread first through third nozzles 56, 58, 60 downwardly to insert the nozzle ports 100a, 100b thereof into the first filling groove 20 of the stator 10. The mixers 98a, 98b mix two liquids of different types supplied from the supply pumps 102a, 102b into the sealant 34, which is then discharged from the nozzle ports 10a, 100b into the first filling groove 20.

Specifically, the distal ends of the nozzle ports 100a, 100b are inserted to a position near a bottom surface of the protrusive portion 22 in the first filling groove 20, as shown in FIG. 17A. Thereafter, the nozzle ports 100a, 100b start discharging the sealant 34. As the height of the sealant 34 discharged onto the protrusive portion 22 increases, the vertically moving unit 64 is controlled to gradually elevate the nozzle ports 100a, 100b synchronously in the direction indicated by the arrow A2, as shown in FIGS. 17B and 17C.

More specifically, the non-illustrated controller outputs a control signal based on the discharged amount of the sealant 34 to the vertically moving unit 64 to control the rotational speed of the second rotary actuator 108. The speed at which, and the distance by which, the vertically moving unit 64 is moved upwardly in the direction indicated by the arrow A2 are thus controlled to displace the distal ends of the nozzle ports 100a, 100b of the first through third nozzles 56, 58, 60 to follow the increasing height of the sealant 34 discharged onto the protrusive portion 22.

By thus controlling the depth to which the nozzle ports 100a, 100b of the first through third nozzles 56, 58, 60 are inserted into the first filling groove 20, it is possible to introduce the sealant 34 reliably around the junctions of the coils 18 in the first filling groove 20 even if the junctions of the coils 18 and other objects become an obstacle to the introduction of the sealant 34, and also possible to avoid air bubbles and sealant sags which would otherwise tend to occur if the nozzle ports 100a, 100b and the surface of the discharged sealant 34 were spaced from each other. Furthermore, since the distal ends of the nozzle ports 100a, 100b do not stick in the discharged sealant 34, the distal ends of the nozzle ports 100a, 100b are prevented from being unduly smeared by the sealant 34.

As shown in FIGS. 17A through 17C, the sealant 34 is introduced onto the protrusive portions 22 in the first filling groove 20 at the respective separate cores 14d, 14j, 14p, and the nozzle ports 100a, 100b are gradually elevated as they continuously discharge the sealant 34. After a preset discharging time has elapsed in the non-illustrated controller, the controller outputs a stop signal to the supply pumps 102a, 102b to stop discharging the sealant 34 from the nozzle ports 100a, 100b. Thereafter, the vertically moving unit 64 is actuated to elevate the nozzle unit 62 including the first through third nozzles 56, 58, 60, and hold the nozzle unit 62 in a position which is spaced a predetermined distance upwardly from the stator 10.

Then, the non-illustrated controller outputs an output signal to the drive motor 140 of the rotary unit 70 to turn the stator 10 counterclockwise through a given angle in the direction indicated by the arrow F (FIG. 2) until the first terminals 24 adjacent to the protrusive portions 22, onto which the sealant 34 has already been applied, face the respective nozzle ports 100a, 100b of the first through third nozzles 56, 58, 60.

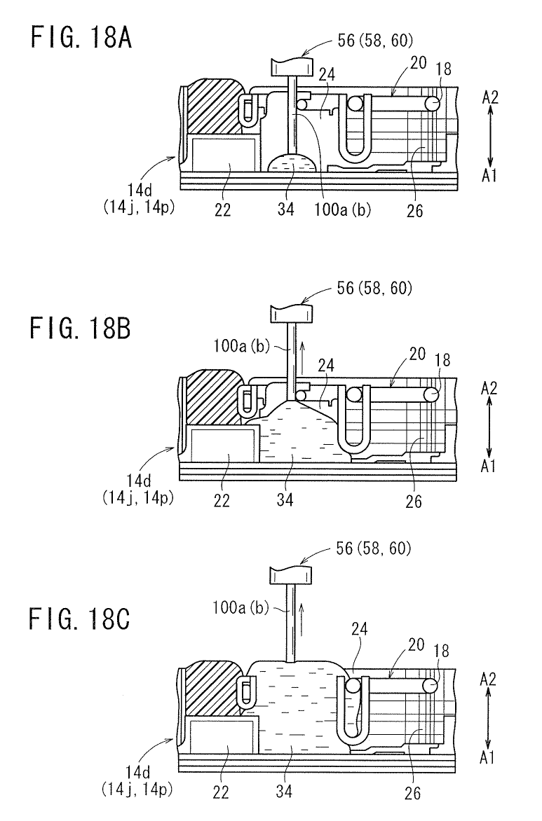

The vertically moving unit 64 is actuated to lower the nozzle unit 62 to insert the nozzle ports 100a, 100b into the first terminals 24 in the first filling groove 20. The nozzle ports 100a, 100b then start discharging the sealant 34 near the bottoms of the first terminals 24, and continuously discharge the sealant 34 while at the same time being gradually elevated, as shown in FIGS. 18A through 18C. Specifically, the nozzle ports 100a, 100b are elevated in synchronism with the increase in the height of the discharged sealant 34. After a preset discharging time has elapsed in the non-illustrated controller, the controller inactivates the supply pumps 102a, 102b to stop discharging the sealant 34 from the nozzle ports 100a, 100b.

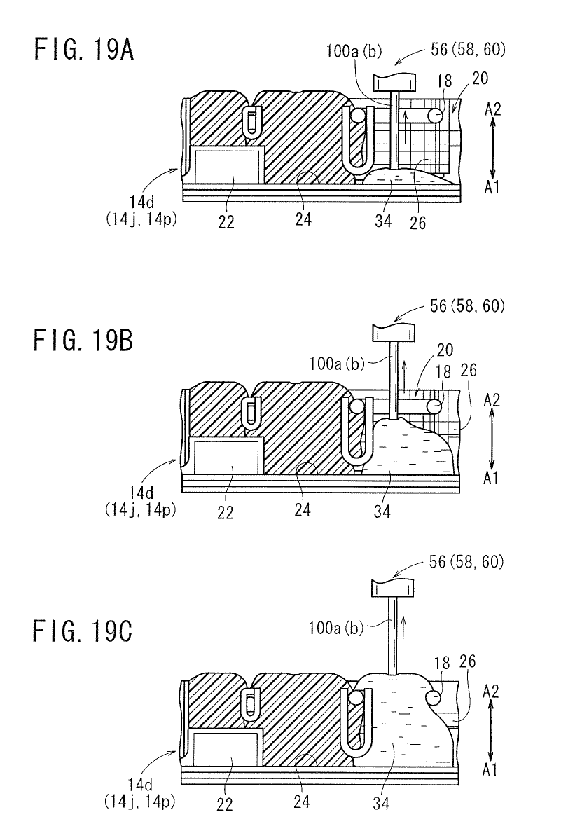

After the sealant 34 has been introduced into the first terminals 24 in the first filling groove 20, the first through third nozzles 56, 58, 60 are brought to and held in the position above the stator 10. Then, the rotary unit 70 turns the stator 10 counterclockwise in the direction indicated by the arrow F through a given angle until the first spaces 26 adjacent to first terminals 24 in the first filling groove 20 face the respective first through third nozzles 56, 58, 60 of the nozzle unit 62. The vertically moving unit 64 is actuated again to lower the first through third nozzles 56, 58, 60 to insert the nozzle ports 100a, 100b into the first spaces 26 of the first filling groove 20. As shown in FIGS. 19A through 19C, the nozzle ports 100a, 100b start discharging the sealant 34 near the bottoms of the first spaces 26, and continuously discharge the sealant 34 while at the same time being gradually elevated. After a preset discharging time has elapsed in the non-illustrated controller, the controller stops discharging the sealant 34 from the nozzle ports 100a, 100b.

In this manner, the sealant 34 is introduced into the first filling groove 20 at the separate core 14d by the first nozzle 56, the sealant 34 is introduced into the first filling groove 20 at the separate core 14p by the second nozzle 58, and the sealant 34 is introduced into the first filling groove 20 at the separate core 14j by the third nozzle 60.

Accordingly, the sealant 34 can be introduced simultaneously at the three separate cores 14d, 14j, 14p of the eighteen separate cores 14a through 14r by the first, second, and third nozzles 56, 58, 60. The sealant 34 is introduced into the first filling groove 20 up to substantially uniform heights in the protrusive portions 22, the first terminals 24, and the first spaces 26 (see FIG. 19C).

After the sealant 34 has been introduced into the first filling groove 20 at the three separate cores 14d, 14j, 14p by the first, second, and third nozzles 56, 58, 60, the vertically moving unit 64 is actuated to elevate the nozzle unit 62 and hold the nozzle unit 62 above the stator 10. The drive motor 140 of the rotary unit 70 is energized again to turn the stator 10 through a given angle counterclockwise in the direction indicated by the arrow F to bring other separate cores 14c, 14k, 14q, which are adjacent to the separate cores 14d, 14j, 14p supplied with the sealant 34, into confronting relationship to the first, second, and third nozzles 56, 58, 60. Then, the sealant 34 is introduced into the first filling groove 20 at the separate cores 14c, 14k, 14q in the same manner as described above.

The process of introducing the sealant 34 into the first filling groove 20 at other separate cores 14a through 14c, 14e through 14i, 14k through 14o, 14q through 14r than the separate cores 14d, 14j, 14p is the same as the above process of introducing the sealant 34 into the first filling groove 20 at the separate cores 14d, 14j, 14p, and will not be described in detail below.

As described above, the stator 10 with the eighteen separate cores 14a through 14r is thus turned through successive given angles counterclockwise in the direction indicated by the arrow F by the rotary unit 70, and the sealant 34 is introduced into the first filling groove 20 successively at the separate cores 14a through 14r by the first, second, and third nozzles 56, 58, 60. Consequently, the sealant 34 can be introduced into the first filling groove 20 simultaneously at three out of the eighteen separate cores 14a through 14r at one time. The time required to introduce the sealant 34 into the first filling groove 20 at all the separate cores 14a through 14r with the three nozzles 56, 58, 60 is thus about one-third of the time required to introduce the sealant 34 into the first filling groove 20 at all the separate cores 14a through 14r with a single nozzle. Stated otherwise, each of the first, second, and third nozzles 56, 58, 60 may introduce the sealant 34 into the first filling groove 20 at six separate cores.

Specifically, for introducing the sealant 34 into the first filling groove 20, the stator 10 is turned through one-third (120°) of the fully circumferential angular interval from the angular position into which the stator 10 is moved by the feed mechanism 68.

Then, the sealant 34 is introduced into the second filling groove 28 at the respective separate cores 14a through 14r.

As described above, after the sealant 34 has been introduced into the first filling groove 20 at all the separate cores 14a through 14r of the stator 10, the vertically moving unit 64 elevates the nozzle unit 62 and holds the nozzle unit 62 above the stator 10. Then, the output signal to the first rotary actuator 82 of the nozzle unit 62 is reversed in polarity to energize the first rotary actuator 82 to rotate the rotor 88 in an opposite direction, i.e., in the direction indicated by the arrow D2 (FIG. 9). The arms 92a, 92b, 92c are pulled to move the sliders 90a, 90b, 90c toward each other in the directions indicated by the arrows C2 along the respective slide rails 86a, 86b, 86c.

The first, second, and third nozzles 56, 58, 60 are now moved toward each other to bring the nozzle ports 100a, 100b thereof into confronting relationship to the second filling grooves 28 of the stator 10.

The direction in which, and the rotational speed at which, the first rotary actuator 82 operates are controlled by the non-illustrated controller to control the distance by which the sliders 90a, 90b, 90c are moved radially inwardly in the directions indicated by the arrows C2 by the rotor 88 for moving the nozzle ports 100a, 100b of the first, second, and third nozzles 56, 58, 60 fixed to the sliders 90a, 90b, 90c to and holding them at respective positions facing the second filling groove 28 of the stator 10.

At this time, as shown in FIG. 2, the first nozzle 56 faces the separate core 14p, the second nozzle 58 faces the separate core 14j, and the third nozzle 60 faces the separate core 14d. The stator 10 has been angularly spaced 120° counterclockwise in the direction indicated by the arrow F from the position wherein the sealant 34 is to be introduced into the first filling groove 20. The positions where the first through third nozzles 56, 58, 60 are located at this time are indicated by blank circular dots in FIG. 2.

The vertically moving unit 64 is actuated to lower the first through third nozzles 56, 58, 60 until their nozzle ports 100a, 100b are inserted into the second filling groove 28 of the stator 10. The mixers 98a, 98b mix two liquids of different types into the sealant 34, which is then discharged from the nozzle ports 100a, 100b into the second filling groove 28. When the sealant 34 is introduced into the second filling groove 28, as with the sealant 34 introduced into the first filling groove 20, the nozzle ports 100a, 100b are gradually elevated by the vertically moving unit 64 as the height of the introduced sealant 34 increases.

Specifically, the first through third nozzles 56, 58, 60 are disposed in facing relationship to the second terminals 30 in the second filling groove 28 at the separate cores 14p, 14j, 14d, and introduce the sealant 34 into the second terminals 30. After a preset discharging time has elapsed, the non-illustrated controller stops introducing the sealant 34 into the second terminals 30. Thereafter, the vertically moving unit 64 is actuated to elevate the first through third nozzles 56, 58, 60, and hold them above the stator 10.

Then, the non-illustrated controller outputs an output signal to the drive motor 140 of the rotary unit 70 to turn the stator 10 clockwise in the direction indicated by the arrow E (FIG. 2) until the second spaces 32 adjacent to the second terminals 30, into which the sealant 34 has already been introduced, face the respective nozzle ports 100a, 100b of the first through third nozzles 56, 58, 60.

The vertically moving unit 64 is actuated to lower the first through third nozzles 56, 58, 60 to insert the nozzle ports 100a, 100b into the second spaces 32 in the second filling groove 28. The nozzle ports 100a, 100b then start discharging the sealant 34 near the bottoms of the second spaces 32, and continuously discharge the sealant 34 while at the same time being gradually elevated. After a preset discharging time has elapsed, the non-illustrated controller stops discharging the sealant 34 from the nozzle ports 100a, 100b.

In this manner, the sealant 34 is introduced into the second filling groove 28 at the separate core 14p by the first nozzle 56, the sealant 34 is introduced into the second filling groove 28 at the separate core 14j by the second nozzle 58, and the sealant 34 is introduced into the second filling groove 28 at the separate core 14d by the third nozzle 60.

Accordingly, the sealant 34 can be introduced simultaneously into the second filling grooves 28 at the three separate cores 14p, 14j, 14d of the eighteen separate cores 14a through 14r by the first, second, and third nozzles 56, 58, 60. The sealant 34 is introduced into the second filling groove 28 up to substantially uniform heights in the second terminals 30 and the second spaces 32.

After the sealant 34 has been introduced into the second filling groove 28 at the three separate cores 14p, 14j, 14d by the first, second, and third nozzles 56, 58, 60, the vertically moving unit 64 is actuated to elevate the nozzle unit 62 and hold the nozzle unit 62 above the stator 10. The drive motor 140 of the rotary unit 70 is energized again to turn the stator 10 through a given angle clockwise in the direction indicated by the arrow E to bring other separate cores 14o, 14i, 14c, which are adjacent to the separate cores 14p, 14j, 14d supplied with the sealant 34, into confronting relationship to the first, second, and third nozzles 56, 58, 60.

The process of introducing the sealant 34 into the second filling groove 28 at other separate cores 14a through 14c, 14e through 14i, 14k through 14o, 14q through 14r than the separate cores 14p, 14j, 14d is the same as the above process of introducing the sealant 34 into the second filling groove 28 at the separate cores 14p, 14j, 14d, and will not be described in detail below.

As described above, the stator 10 with the eighteen separate cores 14a through 14r is thus turned through successive given angles clockwise in the direction indicated by the arrow E by the rotary unit 70, and the sealant 34 is introduced into the second filling groove 28 successively at the separate cores 14a through 14r by the first, second, and third nozzles 56, 58, 60. Consequently, the sealant 34 can be introduced into the second filling groove 28 simultaneously at three out of the eighteen separate cores 14a through 14r at one time. As with the time required to introduce the sealant 34 into the first filling groove 20 at all the separate cores 14a through 14r, the time required to introduce the sealant 34 into the second filling groove 28 at all the separate cores 14a through 14r with the three nozzles 56, 58, 60 is about one-third of the time required to introduce the sealant 34 into the second filling groove 28 at all the separate cores 14a through 14r with a single nozzle.

For introducing the sealant 34 into the second filling groove 28, the stator 10 is turned by the rotary unit 70 through one-third (120°) of the fully circumferential angular interval from the angular position in which the sealant 34 has been introduced fully into the first filling groove 20.

As shown in FIG. 3, the first filling groove 20 of the stator 10 is of a complex structure including the protrusive portion 22, the first terminal 24, and the first space 26 therein. For this reason, the first filling groove 20 may not possibly be filled up with the sealant 34 when the sealant 34 is introduced in the manner described above. To avoid such a sealant introducing failure, the sealant 34 is additionally introduced into the first filling groove 20 after the sealant 34 has been introduced into the second filling groove 28.

Specifically, after the nozzle unit 62 has been elevated by the vertically moving unit 64 upon completion of the introduction of the sealant 34 into the second filling groove 28, the vertically moving unit 64 is actuated to lower the nozzle unit 62, and the first rotary actuator 82 of the nozzle unit 62 is operated to move the sliders 90a, 90b, 90c radially outwardly in the direction indicated by the arrow C1 along the respective slide rails 86a, 86b, 86c, thereby moving the first, second, and third nozzles 56, 58, 60 away from each other into the positions facing the first filling groove 20.

The nozzle ports 100a, 100b of the first, second, and third nozzles 56, 58, 60 are then lowered to positions near the upper surface of the sealant 34 already introduced into the first filling groove 20. Then, the nozzle ports 100a, 100b and the stator 10 are controlled to introduce the sealant 34 depending on the shapes of the protrusive portion 22, the first terminal 24, and the first space 26.

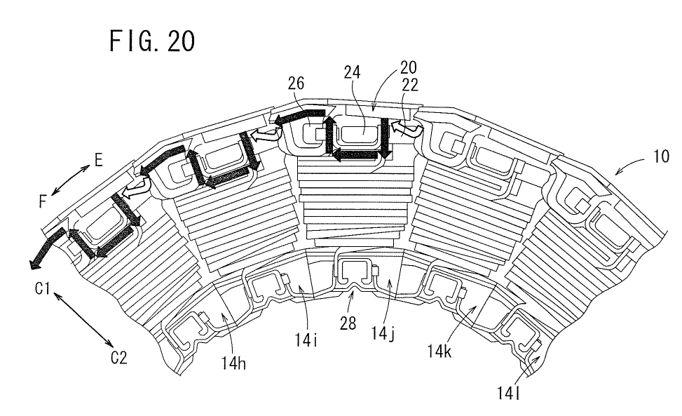

As shown in FIG. 20, a process of additionally introducing the sealant 34 from the third nozzle 60 into the first filling groove 20 at the separate core 14j will be described by way of example below.

First, the third nozzle 60 which faces the protrusive portion 22 discharges the sealant 34 for a predetermined time. Thereafter, the third nozzle 60 is moved radially inwardly in the direction indicated by the arrow C2, and then discharges the sealant 34 for a predetermined time. Then, the rotary unit 70 turns the stator 10 through a given angle clockwise in the direction indicated by the arrow E until the third nozzle 60 faces the first terminal 24. Thereafter, the third nozzle 60 discharges the sealant 34 for a predetermined time. The third nozzle 60 is moved radially outwardly in the direction indicated by the arrow C1, and then discharges the sealant 34 for a predetermined time. During the above operation, the third nozzle 60 is held at a constant height.

Finally, the rotary unit 70 turns the stator 10 through a given angle clockwise in the direction indicated by the arrow E until the third nozzle 60 faces the first space 26, after which the third nozzle 60 discharges the sealant 34 for a predetermined time.

According to the above process, the first filling groove 20 is reliably filled up with the sealant 34 in the protrusive portion 22, the first terminal 24, and the first space 26 at the separate core 14j.

The rotary unit 70 then turns the stator 10 through a given angle clockwise in the direction indicated by the arrow E, and then the sealant 34 is additionally introduced into the first filling groove 20 at the separate core 14i which is adjacent to the separate core 14j to which the sealant 34 has already been additionally applied. The process of additionally introducing the sealant 34 from the third nozzle 60 of the nozzle unit 62 has been described above with reference to FIG. 20. However, the sealant 34 is also additionally introduced from the first and second nozzles 56, 58 at the same time that the sealant 34 is additionally introduced from the third nozzle 60.

After the sealant 34 has been introduced into the first and second filling grooves 20, 28 at the separate cores 14a through 14r of the stator 10, the vertically moving unit 64 moves the nozzle unit 62 to its uppermost position in the preparatory state of the stator manufacturing apparatus 50.

Then, the sealant 34 is introduced into the first, second, and third bus tabs 36, 38, 40.

First, the rotary unit 70 is actuated to turn the stator 10 until the first bus tab 36 reaches a position facing the third nozzle 60 of the nozzle unit 62.

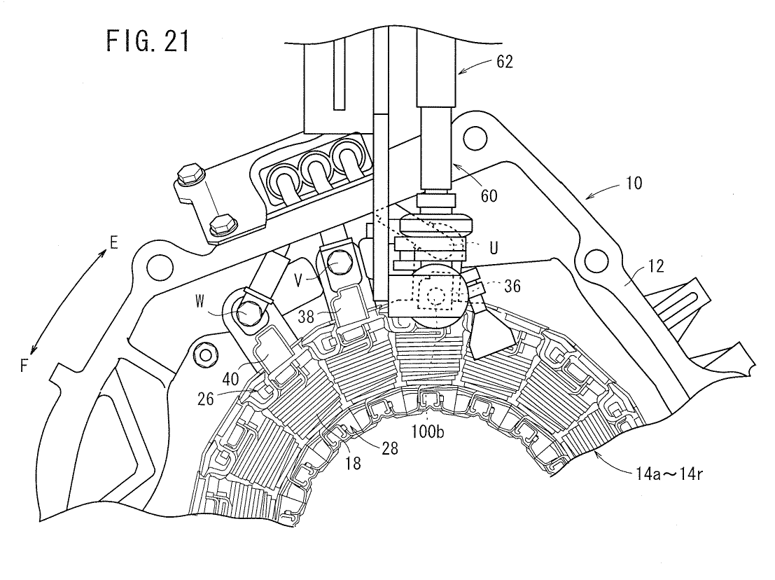

Then, as shown in FIG. 21, while the nozzle port 100b of the third nozzle 60 is being vertically aligned with the first bus tab 36, the nozzle cylinder 104 is actuated to lower the third nozzle 60 in the direction indicated by the arrow A1 toward the stator 10. At this time, the first and second nozzles 56, 58 remain positioned near the base plate 80, and do not descend in unison with the third nozzle 60.

Then, the nozzle port 100b of the third nozzle 60 is inserted into the first bus tab 36, and discharges and introduces the sealant 34 into the first bus tab 36 while at the same time the third nozzle 60 is being gradually elevated by the nozzle cylinder 104 (see a triangular symbol in FIG. 2). After a preset discharging time has elapsed in the non-illustrated controller, the controller outputs a stop signal to the supply pump 102b to stop discharging the sealant 34 from the nozzle port 100b. Thereafter, the nozzle port 100b is elevated above the stator 10, and the stator 10 is turned through a given angle clockwise in the direction indicated by the arrow E.

After the stator 10 has turned until the second bus tab 38 reaches a position facing the third nozzle 60, the third nozzle 60 is lowered again by the nozzle cylinder 104, and starts introducing the sealant 34 into the second bus tab 38. The third nozzle 60 stops discharging the sealant 34 after a preset discharging time has elapsed, as with the first bus tab 36.

Finally, the nozzle port 100b is elevated above the stator 10 by the nozzle cylinder 104, and then the stator 10 is turned through a given angle clockwise in the direction indicated by the arrow E until the third bus tab 40 of the stator 10 reaches a position facing the third nozzle 60. The third nozzle 60 is lowered again, and introduces the sealant 34 into the third bus tab 40.

In this manner, the third nozzle 60 introduces the sealant 34 successively into the first, second, and third bus tabs 36, 38, 40 to suitably insulate and secure the junctions between the input terminals U, V, W and the coils 18 with the sealant 34 as it is cured with heat.

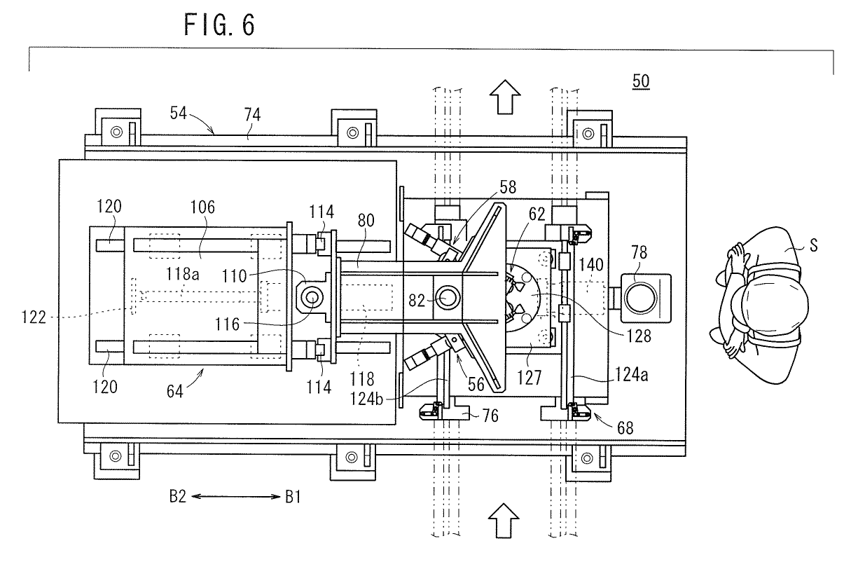

After the sealant 34 has been introduced into the first and second filling grooves 20, 28 and the first, second, and third bus tabs 36, 38, 40, the moving mechanism 132 is operated to lower the adapter 126 including the stator 10. After the adapter 126 is placed on the pallet 127, the feed mechanism 68 shown in FIG. 6 unloads the stator 10 on the pallet 127 out of the stator manufacturing apparatus 50. The process of filling the stator 10 with the sealant 34 is now finished.

According to the present embodiment of the invention, the nozzle unit 62 including the first, second, and third nozzles 56, 58, 60 is vertically movable by the vertically moving unit 64, and the first, second, and third nozzles 56, 58, 60 are radially movable synchronously by the link mechanism 84 when the first rotary actuator 82 is operated. The stator 10 is placed in confronting relationship to the first, second, and third nozzles 56, 58, 60, and is angularly movable or rotatable successively through given angles by the rotary unit 70.

In operation, the stator 10 with the eighteen separate cores 14a through 14r is angularly moved successively through given angles clockwise in the direction indicated by the arrow E or counterclockwise in the direction indicated by the arrow F, and the first, second, and third nozzles 56, 58, 60 introduce the sealant 34 into the first filling groove 20 and the second filling groove 28 successive at the separate cores 14a through 14r. Since the sealant 34 can be introduced by the first, second, and third nozzles 56, 58, 60 simultaneously at three out of the eighteen separate cores 14a through 14r at one time, the time required to introduce the sealant 34 at all the separate cores 14a through 14r with the three nozzles 56, 58, 60 is much shorter than the time required to introduce the sealant 34 at all the separate cores 14a through 14r with a single nozzle. Consequently, the stator 10 can be filled with the sealant 34 highly quickly.

Furthermore, since the first, second, and third nozzles 56, 58, 60 are movable synchronously by the link mechanism 84 when the single first rotary actuator 82 is operated, the stator manufacturing apparatus 50 is much simpler in structure than if the first, second, and third nozzles 56, 58, 60 were actuated by respective actuators.

Moreover, since the third nozzle 60 of the nozzle unit 62 is downwardly movable by the nozzle cylinder 104 independently of the first and second nozzles 56, 58, the sealant 34 can be suitably introduced into the first, second, and third bus tabs 36, 38, 40 which are provided separately from the first and second filling grooves 20, 28. Accordingly, no separate nozzle needs to be added for introducing the sealant 34 into the first, second, and third bus tabs 36, 38, 40, but the stator manufacturing apparatus 50 is enough to introduce sealant 34 into the first, second, and third bus tabs 36, 38, 40 as well as the first and second filling grooves 20, 28. The cost of the stator manufacturing apparatus 50 for filling the first and second filling grooves 20, 28 and the first, second, and third bus tabs 36, 38, 40 with the sealant 34 is relatively low.

In addition, since the stator manufacturing apparatus 50 includes the shift unit 66 for moving the nozzle unit 62 toward the operator S, the first, second, and third nozzles 56, 58, 60 of the nozzle unit 62 can efficiently be serviced for maintenance by the operator S. Specifically, after the sealant 34 has been introduced into the stator 10 by the stator manufacturing apparatus 50, the nozzle ports 100a, 100b of the first, second, and third nozzles 56, 58, 60 can efficiently be cleaned by the operator S.

Although a certain preferred embodiment of the present invention has been shown and described in detail, it should be understood that various changes and modifications may be made therein without departing from the scope of the appended claims.

What is claimed is:

1. A stator manufacturing apparatus for manufacturing a stator having a plurality of cores with respective coils wound therearound, the cores being interconnected in an annular shape, the coils having ends connected at junctions, the stator being connected to feeders for being connected to an external circuit, by introducing a resin to the junctions and curing the introduced resin, comprising:
a plurality of nozzles for discharging the resin, the nozzles being disposed in facing relation to the stator and displaceable radially with respect to the stator;
a nozzle link mechanism for displacing the nozzles in synchronism with each other;
a vertically moving mechanism for vertically moving the nozzles with respect to the stator; and
a rotary mechanism for angularly displacing the stator.

2. A stator manufacturing apparatus according to claim 1, wherein the nozzle link mechanism comprises:
a rotor adapted to be angularly movably disposed in alignment with a central axis of the stator;
a plurality of guide mechanisms extending radially outwardly from the rotor, for guiding the nozzles for radial movement toward and away from the rotor; and
a plurality of link arms operatively connecting the rotor and the guide mechanisms to each other.

3. A stator manufacturing apparatus according to claim 2, wherein the guide mechanisms of the nozzle link mechanism move the nozzles concentrically upon rotation of the rotor, the vertically moving mechanism vertically moves the nozzles with respect to the stator, and the nozzles introduce the resin into the stator while the stator is angularly moved by the rotary mechanism.

4. A stator manufacturing apparatus according to claim 1, further comprising a nozzle lowering mechanism for lowering only one of the nozzles with respect to the other nozzles toward the stator.

5. A stator manufacturing apparatus according to claim 4, wherein the nozzle lowering mechanism comprises a nozzle cylinder.

6. A stator manufacturing apparatus according to claim 1, further comprising a shift mechanism for moving the nozzles outwardly of a position facing the stator.

7. A stator manufacturing apparatus according to claim 6, wherein the vertically moving mechanism includes a body, and the shift mechanism comprises:
a cylinder for horizontally pulling the body; and
a guide rail for guiding the body upon movement.

8. A stator manufacturing apparatus according to claim 1, wherein nozzle ports of the nozzles are elevated to follow a height of the resin when the resin is introduced to the junctions of the coils of the stator.

9. A stator manufacturing apparatus according to claim 1, wherein the nozzles are angularly spaced at equal angular intervals and arranged in a substantially triangular pattern.
